(19) United States
(12) Patent Application Publication
(10) Pub. No.: US 2014/0091963 A1
(43) Pub. Date: Apr. 3, 2014

(54) APPARATUS AND METHOD FOR ANALYZING PROPAGATION OF ELECTROMAGNETIC WAVE IN RADIO WAVE SYSTEM

(71) Applicant: ELECTRONICS AND TELECOMMUNICATIONS RESEARCH INSTITUTE, (US)

(72) Inventors: Myoung-Won JUNG, Chungcheongnam-do (KR); Jong-Ho KIM, Daejeon (KR)

(73) Assignee: ELECTRONICS AND TELECOMMUNICATIONS RESEARCH INSTITUTE, Daejeon (KR)

(21) Appl. No.: 13/728,033

(22) Filed: Dec. 27, 2012

(30) Foreign Application Priority Data
Sep. 28, 2012 (KR) 10-2012-0109141

(51) Int. Cl. G01S 7/40

(52) U.S. Cl. CPC G01S 7/40
USPC 342/173

(57) ABSTRACT

Disclosed are an apparatus and a method for analyzing propagation of an electromagnetic wave by effectively using a ray tracing scheme in a radio wave system, in which; an electromagnetic wave scattered in an electromagnetic wave incident to an interface in a service area is detected; average scattering power for the interface is calculated by the scattered electromagnetic wave; the propagation of the electromagnetic wave in the service area is analyzed based on the average scattering power.

### CROSS-REFERENCE TO RELATED APPLICATIONS

The present application claims priority of Korean Patent Application No. 10-2012-0109141, filed on Sep. 28, 2012, which is incorporated herein by reference in its entirety.

### BACKGROUND OF THE INVENTION

1. Field of the Invention

Exemplary embodiments of the present invention relate to a radio wave system, and more particularly, an apparatus and a method for analyzing propagation of an electromagnetic wave by effectively using a ray tracing scheme in a radio wave system.

2. Description of Related Art

Recently, with an increase in a demand for various types of communication and broadcasting services including a personal communication service, an interest in propagation environment of an electromagnetic wave of an area for providing services, that is, a service area has been increased. In particular, in order to accurately and stably provide a high-speed service to a service area, that is, users, there is a need to more accurately analyze propagation environment of an electromagnetic wave in the service area.

Meanwhile, when an electromagnetic wave is incident to an interface between different media, the electromagnetic wave is reflected in a service area according to an incident angle, a wavelength, and electrical properties of two media such as permittivity, permeability, conductivity, and the like, by a Snell's law. In this case, when the interface is a plane, the electromagnetic wave is regularly reflected at the same reflective angle as the incident angle according to the Snell's law, but when the interface is a rough surface having irregularity rather than a plane, the electromagnetic wave is scattered in several directions, in particular, when the electromagnetic wave is a short wavelength in a millimeter wave band, the reflection and scattering has a big effect on the propagation characteristics of the electromagnetic wave. Therefore, research into the propagation characteristics of the electromagnetic wave in a service area, in particular, the reflection and scattering characteristics of the electromagnetic wave in a millimeter wave band has been conducted.

However, the current radio wave system has not yet been proposed a detailed scheme of accurately analyzing propagation of an electromagnetic wave, in particular, a detailed scheme of analyzing reflection and scattering characteristics of an electromagnetic wave in a millimeter wave band using a ray tracing scheme and accurately and effectively analyzing propagation of an electromagnetic wave according to the reflection and scattering.

Therefore, a need exists for a scheme for effectively and accurately analyzing propagation of an electromagnetic wave according to reflection, scattering, and the like, of an electromagnetic wave in a radio wave system. The file of this patent contains at least one drawing executed in color. Copies of this patent with color drawing(s) will be provided by the Office upon request and payment of the necessary fee.

### SUMMARY OF THE INVENTION

An embodiment of the present invention is directed to an apparatus and a method for analyzing propagation of an electromagnetic wave in a radio wave system.

Another embodiment of the present invention is directed to an apparatus and a method for effectively and accurately analyzing propagation of an electromagnetic wave by minimizing complexity and computation in a radio wave system.

Still another embodiment of the present invention is directed to an apparatus and a method for analyzing propagation of an electromagnetic wave according to reflection, scattering, and the like of the electromagnetic wave by effectively using a ray tracing scheme in a radio wave system.

The foregoing and other objects, features, aspects and advantages of the present invention will be understood and become more apparent from the following detailed description of the present invention. Also, it can be easily understood that the objects and advantages of the present invention can be realized by the units and combinations thereof recited in the claims.

An apparatus for analyzing propagation of an electromagnetic wave in a radio wave system, includes: a detection unit configured to detect an electromagnetic wave scattered in an electromagnetic wave incident to an interface in a service area; a calculation unit configured to calculate average scattering power for the interface by the scattered electromagnetic wave; an analysis unit configured to analyze the propagation of the electromagnetic wave in the service area based on the average scattering power; and an output unit configured to output the propagation of the electromagnetic wave in the service area.

A method for analyzing propagation of an electromagnetic wave in a radio wave system, includes: detecting an electromagnetic wave scattered in an electromagnetic wave incident to an interface in a service area; calculating average scattering power for the interface by the scattered electromagnetic wave; analyzing the propagation of the electromagnetic wave in the service area based on the average scattering power.

### BRIEF DESCRIPTION OF THE DRAWINGS

FIGS. 1 to 4 are diagrams schematically illustrating propagation of an electromagnetic wave in a radio wave system in accordance with an embodiment of the present invention.

FIG. 5 is a diagram schematically illustrating a structure of an apparatus for analyzing propagation of an electromagnetic wave in a radio wave system in accordance with the embodiment of the present invention.

FIG. 6 is a diagram schematically illustrating a process for analyzing propagation of an electromagnetic wave in a radio wave system in accordance with the embodiment of the present invention.

FIGS. 7 to 12 are diagrams schematically illustrating propagation of an electromagnetic wave in a radio wave system in accordance with the embodiment of the present invention.

### DESCRIPTION OF SPECIFIC EMBODIMENTS

Hereinafter, embodiments of the present invention will be described in detail with reference to the accompanying drawings. It is to be noted that only components required to understand an operation according to the present invention is described below and the description of other components will be omitted not to unnecessarily obscure the subject matters of the present invention.

An embodiment of the present invention proposes an apparatus and a method for analyzing propagation of an electromagnetic wave in a radio wave system. In the embodiment of the present invention, in order to stably provide various types of high-speed services to users, propagation of an electromagnetic wave according to reflection, scattering, and the like, of an electromagnetic wave in a service area providing services to users is accurately analyzed by effectively using a ray tracing scheme.

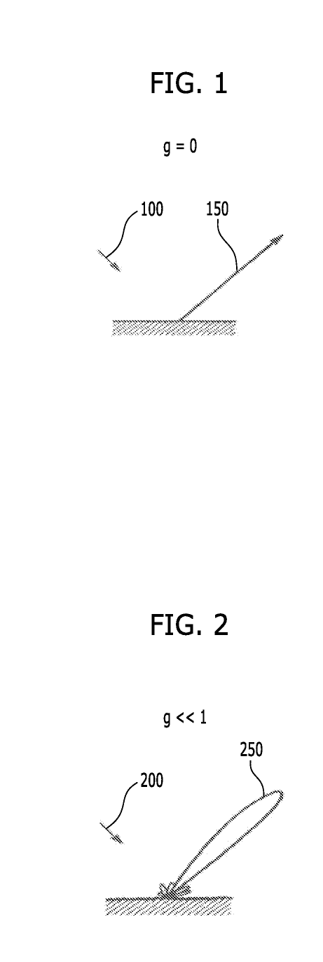

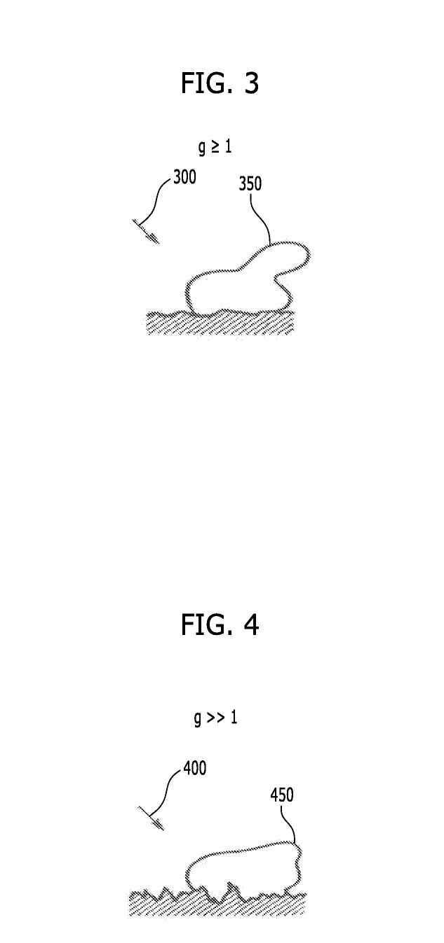

Further, in the embodiment of the present invention, the propagation of the electromagnetic wave in a high frequency band above a millimeter wave in the radio wave system is analyzed. In this case, the moving direction and magnitude of the electromagnetic wave according to the reflection, the scattering, and the like of the electromagnetic wave are analyzed, that is, the propagation of the electromagnetic wave is analyzed by analyzing correlation of roughness, elevation, height, and the like, of a surface of an obstacle that exists in a service area. Meanwhile, in the embodiment of the present invention, the propagation of the electromagnetic wave is analyzed by applying a scattering algorithm using a three-dimensional ray tracking scheme to a scattering pattern of an electromagnetic wave in consideration of a two-dimensional surface, based on a two-dimensional Kirchhoff solution for any rough surface having a normal distribution function in a service area. Hereinafter, the reflection and the scattering according to the surface of the service area in the radio wave system in accordance with the embodiment of the present invention, that is, the propagation of the electromagnetic wave will be described in more detail with reference to FIGS. 1 to 4.

FIGS. 1 to 4 are diagrams schematically illustrating propagation of an electromagnetic wave in a radio wave system in accordance with an embodiment of the present invention.

Referring to FIGS. 1 to 4, electromagnetic waves 100, 200, 300, and 400 are incident to an interface of a service area are reflected and scattered, in particular, when the interface is a plane, that is, as illustrated in FIG. 1, when a parameter g indicating surface roughness of the interface is 0, the electromagnetic wave 100 incident to the interface becomes an electromagnetic signal 150 reflected at the same reflective angle as an incident angle. Further, as illustrated in FIGS. 2 to 4, the electromagnetic signals 200, 300, and 400 incident to the interface become electromagnetic signals 250, 350, and 450 according to the parameter g indicating the surface roughness of the interface.

In this case, in the electromagnetic system in accordance with the embodiment of the present invention, in order to detect and analyze the propagation of the electromagnetic wave in the service area, as described above, electromagnetic wave signals scattered at the interface in the service area, that is, power of scattering signals is calculated. In other words, average scattering power for any rough surface having a normal distribution function is calculated based on the two-dimensional Kirchhoff solution and the propagation of the electromagnetic wave for any interface in the service area is detected and analyzed by applying the scattering algorithm using the three-dimensional ray tracing scheme to the average scattering power. Here, any rough surface, that is, the average scattering power for the interface may be represented by the following Equation 1.

$$〈 {ρρ}^{*} 〉 = {e}^{- g} ( {ρ}_{0}^{2} + \frac{π {T}^{2} {F}_{3}^{2}}{A} {\sum }_{m = 1}^{∞} \frac{{g}^{m}}{m ! m} {e}^{- {v}_{xy}^{2} {T}^{2} / 4 m} ) \\ \sqrt{g} = {v}_{z} σ = 2 π \frac{σ}{λ} ( cos {θ}_{1} + cos {θ}_{2} ) \qquad [ Equation 1 ]$$

In the above Equation 1, <pp*> represents the average scattering power for the interface, g represents a parameter indicating the surface roughness of the interface, m represents a parameter considering a convergence of a series Equation according to the parameter g based on numerical analysis. As illustrated in FIG. 1, when the g indicating regular reflection is 0, it depends on the Snell's law and as illustrated in FIGS. 2 to 4, only when the g indicating the scattering of the electromagnetic wave is not 0, the propagation of the electromagnetic wave is analyzed by calculating the average scattering power for the interface. In particular, as illustrated in FIG. 2, when the g is very smaller than 1, the surface roughness of the interface is very small, which is similar to the case in which the g is 0. Therefore, the convergence of the series Equation is large and thus, in the progression Equation, Equation 1 approximates in consideration of only the case in which m is 1 to approximate the average scattering power for the interface depending on Equation 2.

$$〈 {ρρ}^{*} 〉 = {e}^{- g} ( {ρ}_{0}^{2} + \frac{π {T}^{2} {F}_{3}^{2}}{A} {e}^{- {v}_{xy}^{2} {T}^{2} / 4} ) \qquad [ Equation 2 ]$$

Further, when the parameter g indicating the surface roughness of the interface is 1, the average scattering power for the interface in the regular reflection direction may be approximated like the following Equation 3 and thus, when the parameter g indicating the surface roughness of the interface approximates 1, the average scattering power for the interface is calculated depending on the following Equation 3.

$$D \{ ρ \} = \frac{π {T}^{2}}{A} {\sum }_{m = 1}^{∞} \frac{1}{m ! m} = 0.95 \frac{{T}^{2}}{A} \qquad [ Equation 3 ]$$

In the above Equation 3, D{ρ} represents the average scattering power for the approximated interface. As illustrated in FIG. 4, the surface roughness of the interface is increased and thus, when the parameter g indicating the surface roughness of the interface is larger than 1, an average scattering coefficient <ρ> in Equation 1 becomes 0 and thus, Equations 3 and 1 are the same, that is, the average scattering power D{ρ} for the interface in Equation 3 and the average scattering power <ρρ*> for the interface in Equation 1 are the same.

As Equation 1 and Equation 3 are the same, the average scattering power for the interface can be approximated like the following Equation 4 and the average scattering power for the interface considering only the surface roughness of the interface in the service area may be represented like Equation 4.

$$\begin{matrix}D \{ ρ \} = \frac{π {F}^{2} {T}^{2}}{Ag} exp ( - \frac{{v}_{xy}^{2} {T}^{2}}{4 g} ) \\ = \frac{π {F}^{2} {T}^{2}}{{Av}_{z}^{2} {σ}^{2}} exp ( - \frac{{v}_{xy}^{2} {T}^{2}}{4 {v}_{z}^{2} {σ}^{2}} )\end{matrix} \qquad [ Equation 4 ]$$

In the above Equation 4, as described above, D{ρ} represents the average scattering power for the approximated interface when the parameter g indicating the surface roughness of the interface is larger than 1. In particular, the average scattering power D{ρ} for the interface as represented by Equation 4, which is a value considering only the surface roughness of the interface, represents the average scattering power when the surface is a complete conductor.

Therefore, the propagation analysis of the electromagnetic wave can be more accurately analyzed in the real service area of the radio wave system by analyzing the propagation of the electromagnetic wave in consideration of the scattering characteristics of the electromagnetic wave according to the surface roughness of the interface in the real service area. As such, the average scattering power for the interface in the real service area that is calculated to analyze the propagation of the electromagnetic wave in the real service area may be represented by the following Equation 5.

$${〈 {ρρ}^{*} 〉}_{f} = 〈 {RR}^{*} 〉 {〈 {ρρ}^{*} 〉}_{∞} \\ 〈 R 〉 \approx R ( {θ}_{1} ) \\ {〈 {ρρ}^{*} 〉}_{f} = {( {R}^{\pm } ( {θ}_{1} ) )}^{2} {〈 {ρρ}^{*} 〉}_{∞} \qquad [ Equation 5 ]$$

In the above Equation 5, <ρρ*> represents the average scattering power for the interface in the real service area, R represents a reflection coefficient of the electromagnetic wave, in particular, (+) in the reflection coefficient R^{±} represents a vertical polarization reflection coefficient and (−) represents a horizontal polarization reflection coefficient.

In this case, the average scattering power for the interface in the real service area is more accurately calculated by calculating the average scattering power for the interface in the real service area in consideration of the polarization characteristics of the electromagnetic wave incident to the interface in the real service area, such that the propagation of the electromagnetic wave is more accurately analyzed in the real service area. Here, the average scattering power for the interface in the real service area considering the polarization characteristics of the electromagnetic wave incident to the interface in the real service area may be represented by the following Equation 6.

$$〈 {P}_{r} 〉 = {( {R}^{\pm } ( {θ}_{1} ) )}^{2} \frac{1}{2} {Y}_{0} 〈 {ρρ}^{*} 〉 {\vert {E}_{20} \vert}^{2} \\ 1 = A ( {P}_{i}^{+} ) + ( 1 - A ) ( {P}_{i}^{-} ) \\ [ \begin{matrix}〈 {P}_{r}^{+} 〉 \\ 〈 {P}_{r}^{-} 〉\end{matrix} ] = [ \begin{matrix}{( {R}^{+} ( {θ}_{1} ) )}^{2} \frac{1}{2} {Y}_{0} 〈 {ρρ}^{*} 〉 {\vert {E}_{20} \vert}^{2} & 0 \\ 0 & {( {R}^{-} ( {θ}_{1} ) )}^{2} \frac{1}{2} {Y}_{0} 〈 {ρρ}^{*} 〉 {\vert {E}_{20} \vert}^{2}\end{matrix} ] [ \begin{matrix}A \\ ( 1 - A ]\end{matrix} ] \qquad [ Equation 6 ]$$

In the above Equation 6, Pᵣ represents the average scattering power for the interface in the real service area considering the polarization characteristics of the electromagnetic wave incident to the interface in the real service area, in particular, Pᵣ⁺ represents the average scattering power considering the vertical polarization characteristics of the electromagnetic wave incident to the interface in the real service area and Pᵣ⁻ represents the average scattering power considering the horizontal polarization characteristics of the electromagnetic wave incident to the interface in the real service area.

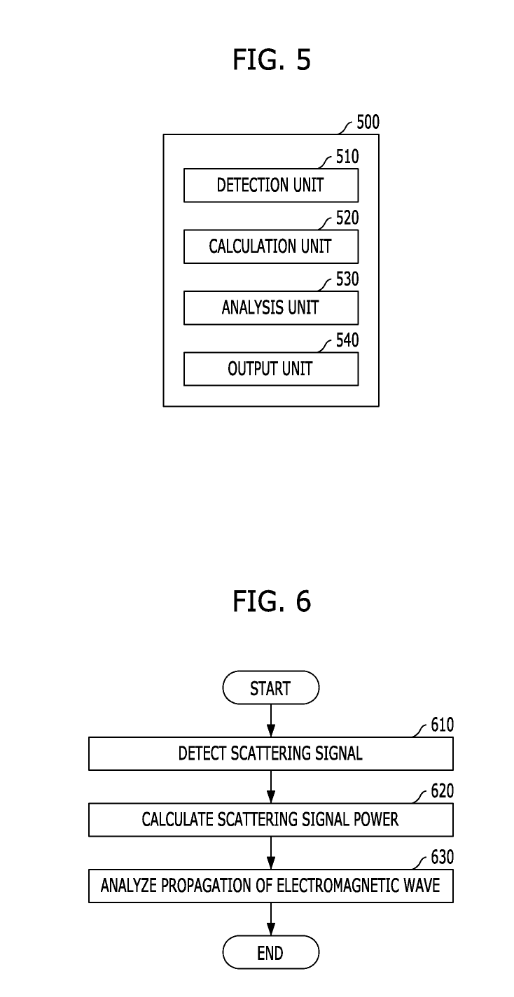

In the radio wave system in accordance with the embodiment of the present invention, as described above, the average scattering power for the interface in the real service area is calculated in consideration of the polarization characteristics of the electromagnetic wave incident to the interface in the real service area and the propagation of the electromagnetic wave in the real service area is more accurately analyzed based on the calculated average scattering power. Herein, an apparatus for analyzing propagation of an electromagnetic wave in a radio wave system in accordance with the embodiment of the present invention will be described in detail with reference to FIG. 5.

FIG. 5 is a diagram schematically illustrating a structure of an apparatus for analyzing propagation of an electromagnetic wave in a radio wave system in accordance with the embodiment of the present invention.

Referring to FIG. 5, an apparatus 500 for analyzing propagation of an electromagnetic wave includes: a detection unit 510 configured to detect an electromagnetic signal scattered at a surface of an interface in the service area, that is, a scattering signal; a calculation unit 520 configured to calculate an average scattering power for an interface in a service area based on the above Equations from the detected scattering signal, that is, the electromagnetic signal scattered at the surface of the interface; an analysis unit 530 configured to analyze the propagation of the electromagnetic wave in the service area based on the average scattering power for the interface in the service area; and an output unit 540 configured to output the propagation of the electromagnetic wave.

Here, the detection unit 510 detects the electromagnetic wave scattered at the interface in the service area, that is, the scattering signal, corresponding to the reflection, the scattering, and the like, for the electromagnetic wave incident to the interface in the service area, in particular, the scattering of the electromagnetic wave according to the surface roughness of the interface.

Further, the calculation unit 520 calculates the average scattering power for the interface in the service area as described in the above Equations, based on the electromagnetic wave scattered at the interface in the service area, that is, the scattering signal. Here, the calculation unit 520 calculates the average scattering power for the interface in the real service area in consideration of the polarization characteristics of the electromagnetic wave incident to the interface in the real service region so as to more accurately analyze the propagation of the electromagnetic wave. In particular, the calculation unit 520 calculates the average scattering power in consideration of the vertical polarization characteristics of the electromagnetic wave incident to the interface in the real service area and calculates the average scattering power in consideration of the horizontal polarization characteristics of the electromagnetic wave incident to the interface in the real service area. Here, the calculation of the average scattering power for the interface in the real service region considering the horizontal polarization characteristics of the electromagnetic wave incident to the interface in the real service area is described in detail based on the above Equations and therefore, the detailed description thereof will be omitted herein.

In addition, the analysis unit 530 more accurately analyzes the propagation of the electromagnetic wave in the real service area based on the average scattering power for the interface in the real service area calculated in consideration of the polarization characteristics of the electromagnetic wave incident to the interface in the real service area and the analyzed propagation of the electromagnetic wave is output through the output unit 540.

That is, in the radio wave system in accordance with the embodiment of the present invention, in order to analyze the propagation of the electromagnetic wave in the service area, the calculation unit 520 calculates the power for the electromagnetic wave scattered at the interface in the service area based on the above Equations, that is, the average scattering power for any rough surface having the normal distribution function based on the two-dimensional Kirchhoff solution and the analysis unit 530 applies the scattering algorithm using the three-dimensional ray tracing scheme to the average scattering power to accurately analyze the propagation of the electromagnetic wave for any interface in the service area. Herein, a process for analyzing propagation of an electromagnetic wave in a radio wave system in accordance with the embodiment of the present invention will be described in detail with reference to FIG. 6.

FIG. 6 is a diagram schematically illustrating a process for analyzing propagation of an electromagnetic wave in a radio wave system in accordance with the embodiment of the present invention.

Referring to FIG. 6, in S610, the apparatus for analyzing propagation of an electromagnetic wave detects the electromagnetic wave scattered at the interface in the service area, that is, the scattering signal, corresponding to the reflection, the scattering, and the like, for the electromagnetic wave incident to the interface in the service area, in particular, the scattering of the electromagnetic wave according to the surface roughness of the interface.

Further, in S620, the average scattering power for the interface in the service area as described in the above Equations, that is, the power of the scattering signal is calculated based on the electromagnetic wave scattered at the interface in the service area, that is, the scattering signal. Here, the average scattering power for the interface in the real service area is calculated in consideration of the polarization characteristics of the electromagnetic wave incident to the interface in the real service region so as to more accurately analyze the propagation of the electromagnetic wave. In particular, the average scattering power is calculated in consideration of the vertical polarization characteristics of the electromagnetic wave incident to the interface in the real service area and the average scattering power is calculated in consideration of the horizontal polarization characteristics of the electromagnetic wave incident to the interface in the real service area. Here, the calculation of the average scattering power for the interface in the real service region considering the horizontal polarization characteristics of the electromagnetic wave incident to the interface in the real service area is described in detail based on the above Equations and therefore, the detailed description thereof will be omitted herein.

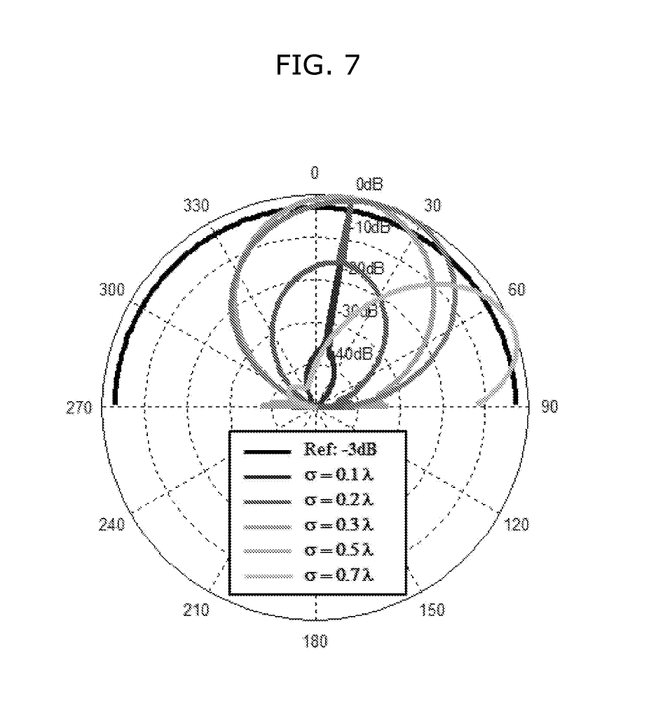

Next, in S630, the propagation of the electromagnetic wave in the real service area is more accurately analyzed based on the average scattering power for the interface in the real service area calculated in consideration of the polarization characteristics of the electromagnetic wave incident to the interface in the real service area. Herein, the propagation of an electromagnetic wave in a radio wave system in accordance with the embodiment of the present invention will be described in detail with reference to FIGS. 7 to 12

FIGS. 7 to 12 are diagrams schematically illustrating propagation of an electromagnetic wave in a radio wave system in accordance with the embodiment of the present invention.

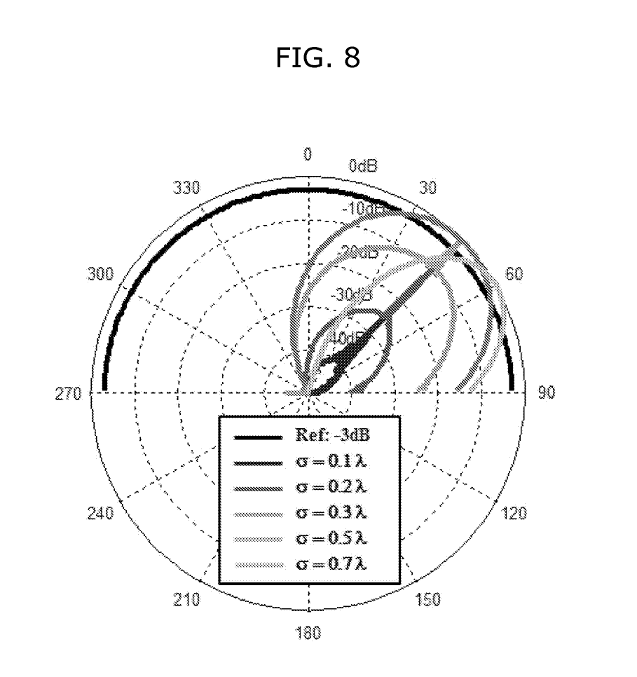

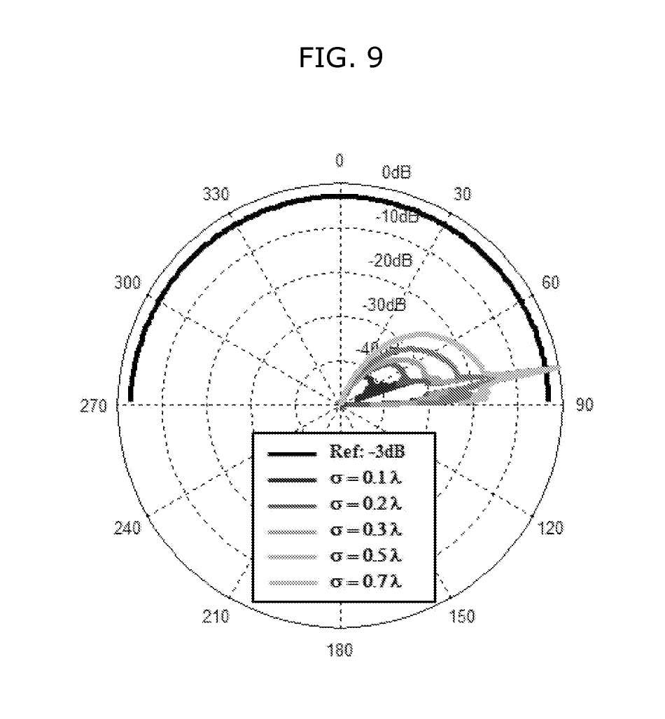

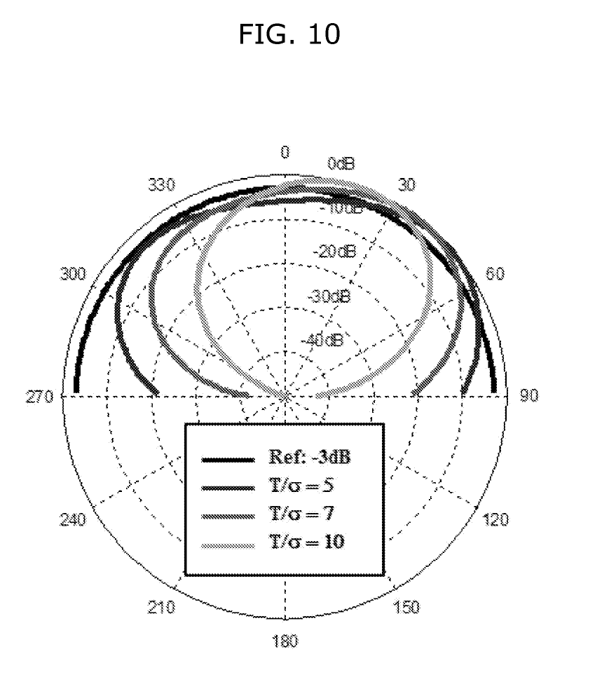

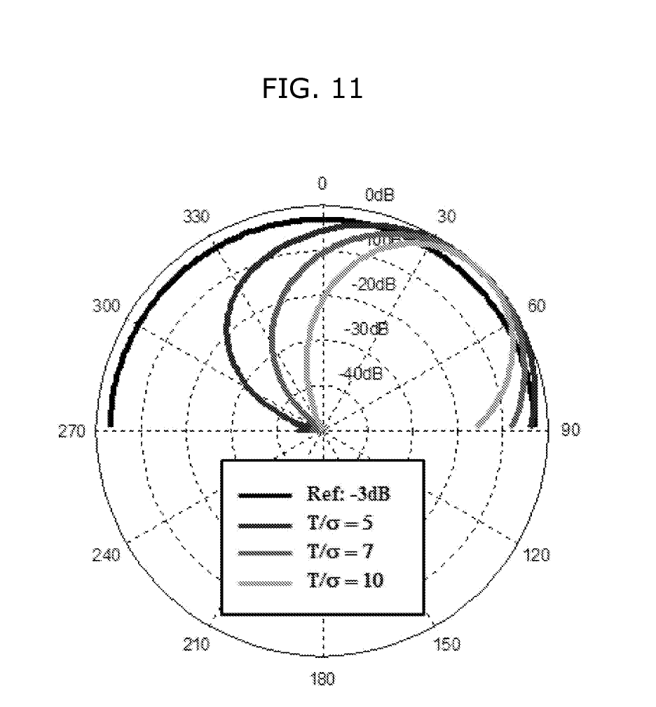

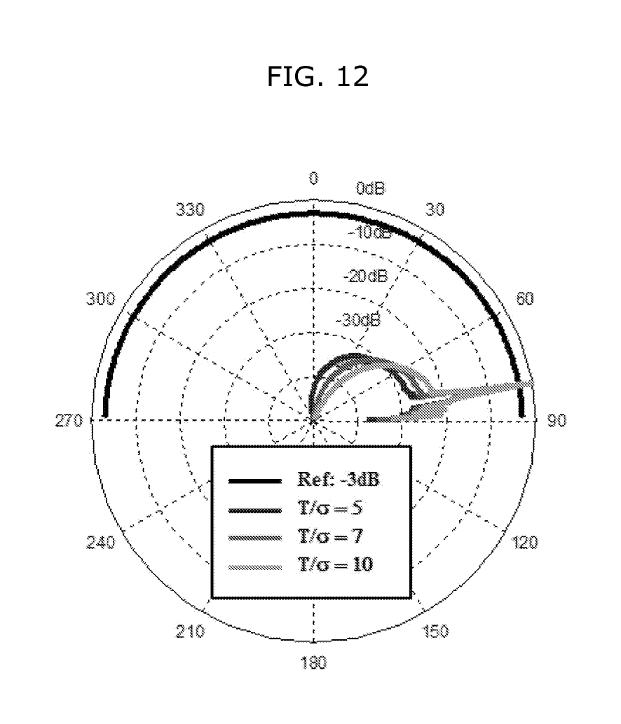

Herein, FIGS. 7 and 10 are diagrams illustrating the propagation of the electromagnetic wave when an incident angle θ1 of the electromagnetic wave incident to the interface in the service area, for example, a reference signal is equal to 10°, FIGS. 8 and 11 are diagrams illustrating the propagation of the electromagnetic wave when an incident angle θ1 of the electromagnetic wave incident to the interface in the service area, for example, a reference signal is equal to 45°, and FIGS. 9 and 12 are diagrams illustrating the propagation of the electromagnetic wave when an incident angle θ1 of the electromagnetic wave incident to the interface in the service area, for example, a reference signal is equal to 80° Further, FIGS. 7 to 9 are diagrams illustrating the propagation of the electromagnetic wave according to a height of rough surface of the interface, for the electromagnetic waves incident at each incident angle in the service area and FIGS. 10 to 12 are diagrams illustrating the propagation of the electromagnetic waves according to a parameter T/σ, for the electromagnetic waves incident at each incident angle in the service area.

First, as illustrated in FIGS. 7 to 9, the electromagnetic wave incident to the interface in the service area, for example, the reference signal has scattering pattern characteristics normalized at each incident angle θ1=10°, θ1=45°, and θ1=80° of the reference signal according to the surface height of the interface, that is, the surface roughness σ.

In particular, as illustrated in FIGS. 7 to 9, the incident angle of the electromagnetic wave incident to the interface in the service area is small, such that the regular reflection component at the low surface roughness σ disappears as the incident angle approaches a right angle from the surface of the interface. That is, as illustrated in FIGS. 7 to 9, as the results of the distribution characteristic analysis of the scattering signal at each incident angle θ1=10°, θ1=45°, and θ1=80°, that is, as in the propagation of the analyzed electromagnetic wave, when the incident angle θ1=10°, the propagation of the electromagnetic wave is not regularly reflected and a main beam direction is deflected out of 0°, at the surface roughness σ=0.3λ and when the incident angle θ1=80°, the propagation of the electromagnetic wave is regularly reflected even at the surface roughness σ=1λ. That is, the propagation of the electromagnetic wave has the reduced regular reflection component and the increased scattering component as the surface roughness σ is increased.

Here, the scattering characteristics of the electromagnetic wave incident to the interface are determined by the surface roughness σ of the interface of the service region determined by the height distribution of the rough surface and the correlation distance of the rough surface. That is, as illustrated in FIGS. 10 to 12, the electromagnetic wave incident to the interface in the service area, for example, the reference signal has scattering pattern characteristics normalized at each incident angle θ1=10°, θ1=45°, and θ1=80° of the reference signal according to the parameter T/σ determined by the height distribution of the rough surface and the correlation distance of the rough surface.

In particular, as illustrated in FIGS. 10 to 12, as the parameter T/σ is small, the scattering effect of the electromagnetic wave incident to the interface of the service area is increased, that is, the scattering component of the electromagnetic wave is increased, thereby increasing a beam width. Here, the result of the distribution characteristic analysis of the scattering signal at each incident angle θ1=10°, θ1=45°, and θ1=80°, that is, as in the propagation of the analyzed electromagnetic wave, when the incident angle θ1=10°, as the parameter T/σ is small, the regular reflection component disappears and thus, the electromagnetic wave is scattered in both directions. Further, at each incident angle θ1=10°, θ1=45°, and θ1=80°, as the incident angle is large, the change according to the parameter T/σ is relatively small in the case of the compensation value.

In the radio wave system in accordance with the embodiments of the present invention, in order to minimize the analysis error of the propagation of the electromagnetic wave in the service area, in particular, the electromagnetic wave having a short wavelength in a millimeter wave band, the propagation of the electromagnetic wave is more accurately analyzed in the service area and the propagation of the electromagnetic wave is accurately analyzed by calculating the average scattering power for the interface in the service area, such that the propagation of the electromagnetic wave is analyzed at high speed with the reduced complexity and the accuracy and efficiency of the analysis and estimation of the propagation of the electromagnetic wave are improved.

The embodiments of the present invention can acquire the propagation of the electromagnetic wave according to the reflection, scattering, and the like, of the electromagnetic wave by effectively using the ray tracing scheme in the radio wave system to minimize the complexity and computation, thereby accurately analyzing and estimating the propagation of the electromagnetic wave at high speed.

Although the exemplary embodiments of the present invention have been disclosed for illustrative purposes, various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

What is claimed is:

1. An apparatus for analyzing propagation of an electromagnetic wave in a radio wave system, comprising:
a detection unit configured to detect an electromagnetic wave scattered in an electromagnetic wave incident to an interface in a service area;
a calculation unit configured to calculate average scattering power for the interface by the scattered electromagnetic wave;
an analysis unit configured to analyze the propagation of the electromagnetic wave in the service area based on the average scattering power; and
an output unit configured to output the propagation of the electromagnetic wave in the service area.

2. The apparatus of claim 1, wherein the calculation unit calculates the average scattering power for the interface in consideration of vertical polarization and horizontal polarization of the electromagnetic wave incident to the interface.

3. The apparatus of claim 2, wherein the analysis unit analyzes the propagation of the electromagnetic wave according to the surface roughness of the interface at incident angles of the electromagnetic wave incident to the interface based on the average scattering power for the interface.

4. The apparatus of claim 2, wherein the analysis unit analyzes the propagation of the electromagnetic wave according to a height distribution and a correlation distance of the roughness surface of the interface at incident angles of the electromagnetic wave incident to the interface based on the average scattering power for the interface.

5. The apparatus of claim 1, wherein the calculation unit calculates the average scattering power for the interface having a normal distribution function by a two-dimensional Kirchhoff solution.

6. The apparatus of claim 5, wherein the calculation unit approximates the normal distribution function according to the surface roughness of the interface to calculate the average scattering power for the interface.

7. The apparatus of claim 5, wherein the analysis unit applies a scattering algorithm using a three-dimensional ray tracing scheme to the average scattering power for the interface to analyze the propagation of the electromagnetic wave.

8. A method for analyzing propagation of an electromagnetic wave in a radio wave system, comprising:
detecting an electromagnetic wave scattered in an electromagnetic wave incident to an interface in a service area;
calculating average scattering power for the interface by the scattered electromagnetic wave; and
analyzing the propagation of the electromagnetic wave in the service area based on the average scattering power.

9. The method of claim 8, wherein in the calculating, the average scattering power for the interface is calculated in consideration of vertical polarization and horizontal polarization of the electromagnetic wave incident to the interface.

10. The method of claim 9, wherein in the analyzing, the propagation of the electromagnetic wave according to the surface roughness of the interface is analyzed at incident angles of the electromagnetic wave incident to the interface based on the average scattering power for the interface.

11. The method of claim 9, wherein in the analyzing, the propagation of the electromagnetic wave according to a height distribution and a correlation distance of the roughness surface of the interface is analyzed at incident angles of the electromagnetic wave incident to the interface based on the average scattering power for the interface.

12. The method of claim 8, wherein in the calculating, the average scattering power for the interface having a normal distribution function is calculated by a two-dimensional Kirchhoff solution.

13. The method of claim 12, wherein in the calculating, the normal distribution function is approximated according to the surface roughness of the interface to calculate the average scattering power for the interface.

14. The method of claim 12, wherein in the analyzing, the propagation of the electromagnetic wave is analyzed by applying a scattering algorithm using a three-dimensional ray tracing scheme to the average scattering power for the interface to analyze the propagation of the electromagnetic wave.
